(19) United States
(12) Patent Application Publication
(10) Pub. No.: US 2013/0090975 A1
(43) Pub. Date: Apr. 11, 2013

(54) Method for Managing a Cellulosic Biomass Harvest

(71) Applicant: PIONEER HI-BRED INTERNATIONAL, INC., Johnston, IA (US)

(72) Inventors: Kyle Joseph Althoff, Grimes, IA (US); Steven J. Corak, Raleigh, NC (US); Ted S. Macy, Cumming, GA (US); Loren Steenhoek, Ankeny, IA (US)

(73) Assignee: PIONEER HI-BRED INTERNATIONAL, INC., Johnston, IA (US)

(21) Appl. No.: 13/649,555

(22) Filed: Oct. 11, 2012

Related U.S. Application Data
(60) Provisional application No. 61/545,871, filed on Oct. 11, 2011.

(51) Int. Cl. G06Q 10/06

(52) U.S. Cl. 705/7.26

(57) ABSTRACT

A method for managing a cellulosic biomass harvest comprises providing one or more harvest locations, receiving at a processor a set of harvest location data associated with the one or more harvest locations, generating at a processor one or more work orders for harvesting cellulosic biomass from the one or more harvest locations based on the set of harvest location data, and storing in a database a cellulosic biomass harvest data set associated with the one or more harvest locations.

### FIELD

Various embodiments of the present invention relate generally to methods for managing harvest data. More specifically, embodiments of the present invention provide a method configured to manage a cellulosic biomass harvest.

### BACKGROUND

Large amounts of cellulosic biomass are required in the production of biofuels, bioenergy, and other bio-renewable products. A bio-renewable product production facility typically contracts with a number of cellulosic biomass providers in a geographic area proximate to the facility for the cellulosic biomass providers to provide cellulosic biomass to the facility. The cellulosic biomass may comprise the above ground portion of cereal crop plants remaining after the grain harvest is completed (known as stover), switchgrass, sugarcane, sorghum, bamboo, wood, or another material suitable for conversion into biofuels, bioenergy, or other bio-renewable products. Managing a cellulosic biomass harvest is typically performed manually, for example by using handwritten notes on paper, manually created spreadsheets, or a combination. For a large production facility, the amount of data involved in managing a cellulosic biomass harvest can be quite large, often including hundreds of cellulosic biomass providers, thousands of harvest locations, tens of thousands of bales of cellulosic biomass, a large fleet of harvesting and transport vehicles, and numerous workers. Manual management of a cellulosic biomass harvest on such a scale is difficult and inefficient. Thus, there is a need for an improved method for managing a cellulosic biomass harvest.

When not used as an input to a production facility, some amount of cellulosic biomass is typically left on the ground, particularly when the cellulosic biomass comprises stover. Leaving stover on the ground can serve an important role in preventing soil erosion. Removing too much stover from a given area during a stover harvest can increase soil erosion. Further, stover left to decompose on the ground can provide valuable soil nutrients. Removing too much stover from a given area during stover harvest can have a detrimental effect on soil nutrient levels and increase chemical use to replace lost nutrients. Thus, there is also a need for a method for managing a stover harvest that minimizes negative environmental impact by selectively harvesting stover in a manner that minimizes soil erosion and leaves adequate stover to replenish soil nutrients.

### SUMMARY

In one embodiment, a method for managing a cellulosic biomass harvest is provided. In various embodiments the method may include providing one or more harvest locations, receiving a set of grain harvest data associated with the one or more harvest locations, generating one or more work orders for harvesting cellulosic biomass from the one or more harvest locations based on the set of grain harvest data, and storing in a database a cellulosic biomass harvest data set associate with the one or more harvest locations.

In some embodiments, providing one or more harvest locations may include generating a map showing the harvest locations. One or more properties of the harvest locations may be displayed on the map.

In some embodiments, the method may further include harvesting cellulosic biomass from the one or more harvest locations to form one or more units of cellulosic biomass. The cellulosic biomass may be selectively harvested according to a harvesting plan. The harvesting plan may be an environmental sustainability plan.

In some embodiments, the method may further comprise indexing the one or more units of cellulosic biomass. Indexing may include assigning a unique identifier to each unit of cellulosic biomass, and may further include affixing an identification device, such as an RFID tag, to each unit.

### BRIEF DESCRIPTION OF THE DRAWINGS

FIG. 1 shows a flowchart for an embodiment of a method for managing a cellulosic biomass harvest.

FIG. 2 illustrates a system for managing a cellulosic biomass harvest.

### DETAILED DESCRIPTION

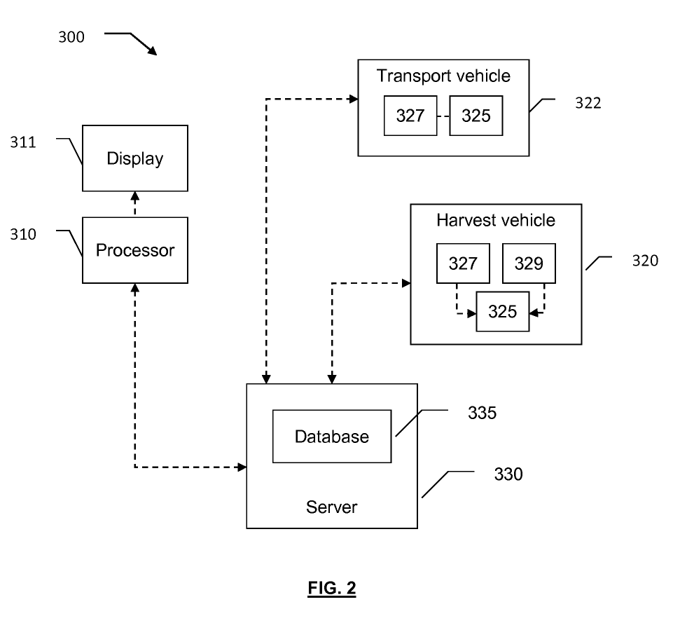

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout. As shown in FIG. 2, in one embodiment, a system 300 for managing a cellulosic biomass harvest may comprise a processor 310, a remote processor 325, a location determining system 327, and server 330. Remote processor 325, location determining system 327, and one or more sensors 329 are situated in a harvest vehicle 320, such as a harvester configured to harvest cellulosic biomass. Server 330 houses a database 335 configured to store data associated with a cellulosic biomass harvest. For example, database 335 may store data associated with a harvest location, cellulosic biomass harvest data associated with a harvest location, or any other data associated with a cellulosic biomass harvest. Processor 310, remote processor 325, and location determining system 327 are communicatively connected to one another. System 300 may further comprise one or more transport vehicles 322 configured to transport units of cellulosic biomass from one location to another. System 300 may further comprise sensors 329 on harvest vehicle 320 configured to collect data related to a cellulosic biomass harvest during a harvesting operation. System 300 may further comprise tarping equipment for wrapping or tarping units of cellulosic biomass. System 300 may further comprise stacking equipment for stacking units of cellulosic biomass.

Processor

Processor 310 is configured to run cellulosic biomass harvest management software. For example, the software is configured to display a map showing available cellulosic biomass harvest locations and other data associated with a cellulosic biomass harvest. In addition, the software may be used to identify and contract with cellulosic biomass providers and issue work orders to one or more harvest vehicles 320, transport vehicles 322, tarping equipment, stacking equipment, or workers. Processor 310 communicates with server 330 to transmit to and receive from database 335 data associated with a cellulosic biomass harvest. Processor 310 may run algorithms that coordinate logistics of one or more harvest vehicles 320, transport vehicles 322, tarping equipment, stacking equipment, or workers, determining the most efficient and economical ways to harvest and transport units of cellulosic biomass based on the locations of the vehicles and other metrics associated with the cellulosic biomass harvest. Software running on processor 310 may generate and transmit work orders to various parts of system 300. For example, software running on processor 310 may generate and transmit work orders to a harvest vehicle 320 to harvest cellulosic biomass from a particular harvest location, or to a transport vehicle 322 to transport units of cellulosic biomass from one location to another, or to tarping equipment to wrap or tarp units of cellulosic biomass at a harvest location, or to stacking equipment to stack units of cellulosic biomass at a harvest location, or to a worker that operates a harvest vehicle, transport vehicle, tarping equipment, stacking equipment, or to a mobile worker using a suitable handheld device such as a mobile telephone, a laptop, or a tablet computer. Processor 310 may comprise one or more general purpose computers configured to run software for managing a cellulosic biomass harvest. Alternatively, processor 310 may comprise a mobile device such as a cellular telephone or tablet computer configured to run software for managing a cellulosic biomass harvest. A display device 311 is associated with processor 310. In one embodiment, display device 311 comprises a monitor connected to processor 310. Alternatively, display device 311 comprises a screen of a mobile device, such as a cellular telephone or a tablet computer.

Harvest Vehicles and Transport Vehicles

One or more harvest vehicles 320 harvest cellulosic biomass from the harvest locations. A harvest vehicle 320 may comprise a specialized harvester configured to harvest cellulosic biomass. In one embodiment, harvest vehicle 320 may comprise the system disclosed in U.S. Ser. No. 61/537,680, which is incorporated by reference. In other embodiments, harvest vehicle 320 may comprise a harvester, windrower, or any other vehicle, implement, or combination of vehicles and implements capable of harvesting cellulosic biomass.

Harvest vehicle 320 may be equipped with a location determining system 327 configured to determine the location of harvest vehicle 320. Harvest vehicle may also be equipped with a remote processor 325 configured to run software for collecting and analyzing data associated with a cellulosic biomass harvest. Location determining system 327 communicates location information to remote processor 325. Remote processor 325 associates location data supplied by the location determining system 327, and communicates data and location information to database 335.

Harvest vehicle 320 may be equipped with one or more sensors 329 configured to determine metrics associated with the cellulosic biomass harvest. In one embodiment, sensor 329 may comprise a moisture sensor configured to determine the moisture of a unit of cellulosic biomass as harvest progresses. In another embodiment, sensor 329 may comprise a weight sensor configured to determine the weight of a unit of stover as harvest progresses. In another embodiment, sensor 329 may comprise a composition sensor configured to determine the composition of a unit of stover as harvest progresses such as carbohydrate, lignin, ash and other properties. Sensor 329 may comprise any sensor capable of being installed on harvest vehicle 320 and measuring data associated with the harvest. Sensor 329 communicates collected data to remote processor 325. Remote processor 325 associates location data supplied by the location determining system 327 with data collected by one or more sensors 329, and communicates data and location information to database 335.

One or more transport vehicles 322 transport harvested units of cellulosic biomass from one location to another. Transport vehicle 322 may comprise a truck, a trailer, or any other vehicle, implement, or combination of vehicle and implement capable of transporting units of cellulosic biomass from one location to another. Transport vehicle 322 may be equipped with a location determining system 327 configured to determine the location of transport vehicle 322 and communicate location information to database 335. Transport vehicle 322 may also be equipped with a remote processor 325. Remote processor 325 associates location data supplied by the location determining system 327 with data related to transporting units of cellulosic biomass, and communicates the data to database 335.

Remote Processor

Remote processor 325 is configured to run software for collecting, analyzing, and displaying data associated with a cellulosic biomass harvest. In one embodiment, remote processor 325 may comprise a specialized precision agriculture display mounted in the cab of harvest vehicle 320, in a transport vehicle 322, on tarping equipment, on stacking equipment, or any other vehicle used in the harvest of cellulosic biomass. Remote processor 325 is configured to run software to display, collect and analyze data associated with the cellulosic biomass harvest. In another embodiment, remote processor 325 may comprise a mobile device configured to run software that displays, collects, and analyzes data associated with the cellulosic biomass harvest. Alternatively, processor 310 may perform the role of remote processor 325. Location determining system 327 communicates location information to remote processor 325, either wirelessly or through a wired connection, to determine the location of harvest vehicle 320, transport vehicle, tarping equipment, stacking equipment, worker, or units of cellulosic biomass. One or more sensors 329 located on harvest vehicle 320 may communicate data to remote processor. Remote processor 325 analyzes data received from location determining system 327 and sensors 329, associating data with location, and communicating location and other data to database 335. Data associated with the harvest and condition of harvest vehicle 320 may be displayed on remote processor 325 during operation of harvest vehicle 320.

In one embodiment, remote processor 325 runs software for executing a variable rate cellulosic biomass harvest. In this embodiment, data including, but not limited to, soil type, imagery of vegetative cover, crop grain yields, digital elevation models, and soil test results are used by the software to determine which areas of the harvest location are suitable for stover harvest. Remote processor 325 communicates with various systems of harvest vehicle 320 to harvest varying amounts of cellulosic biomass based on the data, which is either communicated to remote processor 325 by sensors 329 or uploaded from database 335.

In another embodiment, precision agriculture display 325 is installed on a transport vehicle 322. In this embodiment, remote processor 325 associates location data supplied by the location determining system 327 with data related to transporting units of cellulosic biomass, and communicates the data to database 335. Precision agriculture display 325 may receive work orders for transporting units of cellulosic biomass from processor 310.

In another embodiment, precision agriculture display 325 is installed on tarping equipment. In this embodiment, precision agriculture display associates location data with data associated with wrapping or tarping units of cellulosic biomass, and communicates the data to database 335. Precision agriculture display 325 may receive work orders for tarping units of cellulosic biomass from processor 310. For example, the type of storage (e.g. tarped or un-tarped, inside or outside storage, etc.) to be employed at a harvest location may be stored in database 335. Processor may send a work order for wrapping or tarping units of cellulosic biomass to a remote processor installed on tarping equipment, or to a mobile device used by a worker being dispatched to perform the tarping operation.

In another embodiment, precision agriculture display 325 is installed on stacking equipment. In this embodiment, precision agriculture display associates location data with data associated with stacking units of cellulosic biomass, and communicates the data to database 335. Precision agriculture display 325 may receive work orders for stacking units of cellulosic biomass from processor 310.

Remote processor 325 is configured to receive work orders from processor 310. Workers or equipment may be dispatched to perform various aspects of a cellulosic biomass harvest as a result of work orders. The status and progress of the various workers and equipment is reported back to processor 310 such that the progress of the harvest can be stored in database 335.

Location Determining System

Location determining system 327 is installed in or on a vehicle, either harvest vehicle 320, transport vehicle 322, tarping equipment, stacking equipment, or other vehicle. Location determining system 327 may also be installed on a mobile device used by a worker or in a vehicle. Location determining system 327 determines the location of the vehicle or worker, and communicates this location information to remote processor 325 or to processor 310. Location determining system 327 is also used to determine the area harvested to quantify the removal rate, and communicates this information to remote processor 325. The area harvested may be recorded for each unit of cellulosic biomass. Alternatively, the area harvested data may pertain to the harvest location, and may include the number of units at the harvest location, whether the units are tarped or not, and whether the units are stored inside or outside. Location determining system 327 may comprise a global positioning system (GPS) or other system capable of determining and communicating geospatial coordinates of a given location.

Server

Server 330 runs software for implementing database 335. All data associated with the cellulosic biomass harvest is stored in database 335. Processor 310 and remote processor 325 communicate with server 330 to store data in database 335. Server 330 may comprise commercially available server equipment, a general purpose computer configured to run database 335 software, or any other equipment capable of transmitting data, receiving data, and running database 335.

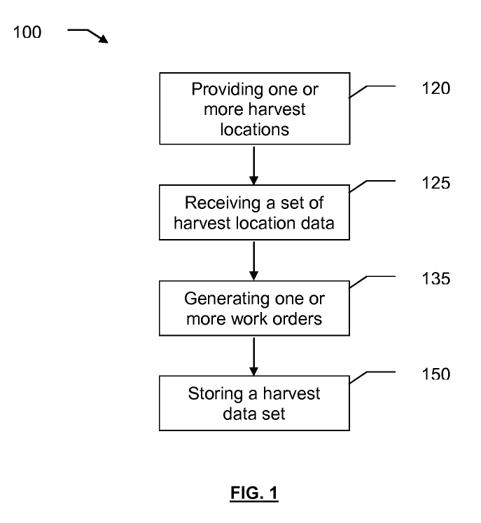

As shown in FIG. 1, in one embodiment, a method 100 for managing a cellulosic biomass harvest comprises providing one or more harvest locations, receiving a set of harvest location data associated with the one or more harvest locations, generating one or more work orders for harvesting cellulosic biomass from the one or more harvest locations based on the set of harvest location data, and storing in a database a cellulosic biomass harvest data set associated with the one or more harvest locations.

Providing one or more Harvest Locations

Method 100 begins with step 120, which comprises providing one or more harvest locations. Harvest locations are areas that have been identified as being available for cellulosic biomass harvest. Often harvest locations comprise fields owned by individual landowners who have contracted with a production facility to provide cellulosic biomass to the production facility. Each harvest location may be displayed as an icon on a map, or the boundaries of each harvest location may be drawn on the map. The boundaries of each harvest location may be drawn using geo-referenced aerial photography, imported from publically available common land unit (CLU) data, or imported from a location determining system such as GPS. The location of each harvest location is stored in database 335, which resides on server 330. The map is provided on a display device 311 associated with processor 310. By providing a map showing a plurality of cellulosic biomass harvest locations, one can easily identify all of the available harvest locations in a particular geographic area, and areas that may potentially be harvest areas may be identified. In addition, harvesting equipment may be dispatched based on the map.

Before, during, or after a bio-renewable product production facility is constructed, many cellulosic biomass providers near the facility are contracted to provide cellulosic biomass to the facility. In one embodiment, a geographic area surrounding the facility is divided into a number of zones by software running on processor 310. For example, the area within a particular radius of the facility may be divided into a number of zones. Data for the geographic area may be displayed by the software. For example, publically available common land unit data, weather data, soil type data, or other data relevant to determining the suitability of harvest locations within the zone may be viewed on a zone map displayed on display 311 of processor 310. Workers may then approach landowners owning land identified in the zone map to contract with the facility to provide cellulosic biomass to the facility.

Software running on processor 310 may facilitate the enrollment of cellulosic biomass providers. Workers may enter data pertaining to a particular provider into software running on processor 310, and processor 310 communicates the data to database 335. The software may also generate contracts or similar documentation to facilitate the enrollment of cellulosic biomass providers.

Receiving a set of Harvest Location Data

Method 100 continues with step 125, receiving at a processor a set of harvest location data associated with the one or more harvest locations. Data associated with a harvest location may include soil type, grain harvest yield, completion status of grain harvest at the harvest location, or other data. The data is sent to processor 310 for use by management software, and is also stored in database 335. The data may be displayed on a map using display 311. The harvest location data is used by processor 310 to make management decisions. For example, a harvest location may be skipped if grain harvest yield is below a defined threshold. In another example, processor 310 generates and sends a work order to dispatch a cellulosic biomass harvest vehicle 320 and workers once processor 310 receives data indicating that the grain harvest is complete at the harvest location.

In one embodiment, the harvest location data set may comprise soil types of each harvest location. Soil types of the harvest area may be determined by soil tests performed at various test points throughout the harvest area. The soil type at each test point is associated with the geospatial coordinates of the test point. Both the soil type and the coordinates for each test point are stored in database 335 on server 330, and may be displayed on a display device 311 associated with processor 310. Soil type data may be used to generate a series of zones within the harvest location. Different harvest practices may be used in each zone of the harvest location. For example, in zones for which the soil type is highly susceptible to soil erosion, minimal or no cellulosic biomass may be harvested, while most or all of the cellulosic biomass may be harvested in areas of low susceptibility to soil erosion. In addition to soil type data, remotely sensed imagery of vegetative cover, crop grain yields, digital elevation models, and soil test results may be used to create zones and determine the suitability of each zone for cellulosic biomass harvest.

Generating one or more Work Orders

Method 100 continues with step 135, generating one or more work orders for harvesting cellulosic biomass from the one or more harvest locations based on the set of harvest location data. A work order specifies a task to be performed at a particular harvest location, and may include data associated with the harvest location.

A work order system operating on processor 310 may generate and transmit to one or more vehicles, equipment, or workers, work orders for completion of various tasks associated with harvesting cellulosic biomass. In one embodiment, the work order system can pre-assign crews of workers to perform a particular task at a particular harvest location. Work orders may be generated based on rules that connect completion of one task to the start of another task. For example, a rule may specify that workers receive a work order to perform cellulosic biomass harvest at a harvest location when processor 310 receives notification that grain harvest at that harvest location is complete.

Using a work order system, information generated by an action in one task is cascaded to another task. In one embodiment, as a grower completes grain harvest at the harvest location, data associated with the grain harvest is collected. The grower may collect the yield, type of header used, moisture level, or other information. The data collected during the grain harvest may be cascaded to the stover harvest/baling workers in the next task. When information is cascaded from one task to the next, greater efficiency and other benefits are achieved. For example, when information is cascaded between tasks, workers are more likely to arrive at the harvest location with the correct equipment. As another example, workers may skip stover harvest at a location if the grain harvest yield is below a threshold. As another example, workers may defer harvest if the moisture level is above a threshold. As another example, grain harvest data may be used to determine how much stover to harvest.

In one embodiment, grain harvest at a harvest location triggers a work order for harvesting stover at the harvest location. Once the stover harvest work order is complete, it triggers an audit work order (e.g. counting harvested units, qualifying the units that were collected, etc.) Completion of the stover harvest work order may also trigger a transporting work order or a tarping work order. The completion of the audit work order triggers a grower audit in which the work order system sends a notification to the grower, and the grower may verify the results of the audit work order. The completion of the audit work order may also trigger a sampling work order. Completion of the sampling work order may trigger an analysis work order. Through the use of the work order system, the dispatch of vehicles, equipment, and workers is staggered, leading to greater efficiency and equipment utilization. For example, a transport vehicle 322 is not sent to a harvest location where the stover harvest work order is not yet compete.

The work order system may generate reports to be displayed on display 311 or on a display associated with one or more remote processors 325. Reports may overall harvest performance, including performance of an individual harvest location and overall progress of the stover harvest and inventory. Decisions may be made based on the number of units in inventory, or machinery may be swapped based on the reported results. Processor 310 may generate daily work order status reports describing the status of individual work orders or overall system status across all work orders and tasks.

Fleet or workforce management data may be performed. In one embodiment, a location determining system 327 is installed on each of one or more harvest vehicles 320, transport vehicles 322, tarping equipment, or stacking equipment. Location determining system 327 is configured to determine and communicate the geospatial coordinates of the harvest vehicle 320, transport vehicle 322, tarping equipment, or stacking equipment. Location determining system 327 may communicate the coordinates of the vehicle to remote processor 325 which transmits the location of the vehicle to database 335. Alternatively, location determining system may comprise a self-contained system capable of transmitting the location and other vehicle data directly to database 335. Software running on processor 310 is configured to obtain the location data of each vehicle from database 335 and display the location of each vehicle. The location of each vehicle may be displayed on a map. By displaying the location of each vehicle, vehicles may be dispatched to perform harvesting activities in a given harvest location. Algorithms running on processor 310 may optimize logistics associated with harvest and transportation of units of cellulosic biomass, dispatching vehicles to perform harvest and transportation activities in the most efficient and cost effective manner. In another embodiment, each worker may be equipped with a mobile device, such as a cellular telephone, laptop computer, or tablet computer, capable of determining the location of each worker and transmitting each worker's location to database 335. Software running on processor 310 is configured to obtain the location data of each worker from database 335 and display the location of each worker on a map. By displaying the location of each worker, individuals may be dispatched to perform harvesting activities in a given harvest location. Algorithms running on processor 310 may optimize logistics associated with harvest and transportation of units of cellulosic biomass, dispatching workers to perform harvest and transportation activities in the most efficient and cost effective manner. In addition to recording the location of each harvest vehicle 320 and transport vehicle 322, other metrics associated with each vehicle may be stored in database 335. For example, the type of vehicle, a unique identifier for each vehicle, total load capacity of each vehicle, and current load being carried by each vehicle may be stored in database 335.

Harvesting comprises harvesting cellulosic biomass from the plurality of harvest locations to form one or more units of cellulosic biomass. In one embodiment, a unit of cellulosic biomass comprises a bale. Harvesting is performed by one or more harvest vehicles 320. In one embodiment, data related to the harvest is collected by remote processor 325 as the harvest operation progresses. For example, geospatial coordinates of the subset of the harvest location harvested to form a particular unit of cellulosic biomass may be determined by location determining system 327 and communicated to remote processor 325 as the harvest operation progresses. In another embodiment, specialized sensors 329 installed on harvest vehicle 320 collect data associated with a unit of cellulosic biomass as the harvesting operation progresses. For example, sensors 329 may comprise one or more weight sensors configured to collect each unit's weight, moisture sensors configured to collect each unit's moisture content, sensors configured to measure each unit's compositional properties, or some combination of sensors. Sensors 329 communicate location and other collected data to remote processor 325. Remote processor 325 may associate the location and other data with a unit of cellulosic biomass deposited at a particular location, and this data is transmitted to database 335.

The cellulosic biomass may be selectively harvested according to a harvest plan. A harvest plan may be created using software running on processor 310 and configured to create variable rate harvest prescriptions. The software may take as inputs soil types, remotely sensed imagery of vegetative cover, crop grain yields, digital elevation models, soil test data, location data, or other data indicative of the amount of stover available for harvest at a particular spot in a harvest location. The software may output a harvest plan comprising a prescription indicating the amount of stover the harvest vehicle 320 should harvest at each particular spot in the harvest location. The harvest plan is communicated to a remote processor 325 installed on a harvest vehicle 320, and software running on remote processor 325 communicates instructions to various systems of harvest vehicle 320 to selectively harvest cellulosic biomass according to the harvest plan.

In one embodiment, the harvest plan comprises an environmental sustainability plan. When not used as an input to a production facility, some amount of cellulosic biomass is typically left on the ground, particularly when the cellulosic biomass comprises stover. Leaving stover on the ground can serve an important role in preventing soil erosion and maintaining soil quality. Removing too much stover from a given area during a stover harvest can increase the risk of excessive soil erosion and decreased soil quality. When the harvest plan comprises an environmental sustainability plan, some or all stover is left on the ground in portions of the harvest area that are determined to be at risk, while most of the stover is harvested from portions of the harvest area that have been determined to be less at risk.

Each unit of cellulosic biomass may be indexed. In one embodiment, indexing each unit of cellulosic biomass comprises assigning a unique identifier to each unit of cellulosic biomass. The unique identifier may be used to associate corresponding data stored in database 335 with each unit of cellulosic biomass.

Indexing may further comprise affixing an identification device to each unit of cellulosic biomass such that each unit can be traced from harvest location to production facility, and so that data associated with a particular unit of cellulosic biomass can be retrieved. The identification device may comprise a human readable tag, a barcode, a radio frequency identification (RFID) tag, or other device capable of being attached to a unit of cellulosic biomass and uniquely identifying each unit of cellulosic biomass. Data associated with each unit of cellulosic biomass may be coded or stored directly on the identification device. Alternatively or additionally, data associated with each unit of cellulosic biomass is stored in database 335, and may be retrieved and viewed using processor 310. The identification device may be affixed to the unit by harvest vehicle 320 as harvest progresses. Alternatively, the identification device may be manually attached after the unit is deposited in the harvest location.

Indexing allows each unit of cellulosic biomass to be traced from harvest location to production facility. During harvesting, geospatial coordinates of the subset of the harvest location harvested to form a particular unit of cellulosic biomass may be determined by location determining system 327 and communicated to remote processor 325 as the harvest operation progresses. This source location data is transmitted to database 335, and associated with the particular unit of cellulosic biomass, along with the geospatial coordinates describing where the unit of cellulosic biomass is deposited in the field during harvest. If the unit of cellulosic biomass is moved from the harvest location to another location, such as a storage facility, the identification device is scanned at the time of transport, and geospatial coordinates of the new location of the particular unit of cellulosic biomass are transmitted to database 335. By so doing, each unit of cellulosic biomass can be tracked from the harvest location to production facility, and data associated with each unit of cellulosic biomass can be easily retrieved from database 335.

Storing a Harvest Data set Associated with one or more Harvest Locations

Method 100 continues with step 150. Step 150 comprises storing in a database 335 a harvest data set associated with one or more harvest locations. The harvest data set may include the number of units at a harvest location, whether the units are tarped or un-tarped, whether the units are stored indoors or outdoors, or any other information pertaining to the cellulosic biomass harvest at the harvest location. If the units of cellulosic biomass at a harvest location are indexed, the data set may also include each unit's weight, moisture content, composition, or location. In one embodiment, cellulosic biomass harvest data may be collected in real time by remote processor 325 as harvest or another task progresses. The data is transmitted from remote processor 325 to database 335, and processor 310 obtains the data. Processor 310 may display the harvest data on a map. In another embodiment, cellulosic biomass harvest data may be collected after harvest. In this embodiment, data would be recorded using processor 310, which would transmit the data to database 335. Data related to the harvested cellulosic biomass may be displayed on a map, allowing units that meet the particular needs of the production facility to be selectively transported to the facility as needed.

Data is communicated to database 335 by processor 310 and by remote processor 325. Data may be communicated to database 335 by sending an email in a pre-defined format via processor 310 to server 330. Server 330 runs software that is configured to import the data into database 335. In one embodiment, workers may manually take samples for further analysis or may collect other information associated with one or more harvest locations. The collected data or results of the analysis are stored in the pre-defined format using software running on processor 310. The data stored in the pre-defined format is then emailed to server 330 using email software running on processor 310, and server 330 imports the data into database 335.

Server 330 may send notifications to a set of pre-defined contacts. In one embodiment, server 330 may send an email to a distribution list stored on server 330 when a pre-defined event occurs. For example, server 330 may send an email to the distribution list when a cellulosic biomass provider completes grain harvest, and harvest areas owned by the provider are ready for harvest of cellulosic biomass. Server 330 also stores an indicator in database 335 that the harvest areas are ready for harvest.

In another embodiment, server 330 may generate reports of data stored in database 335. For example, server 330 may generate a report showing all harvest areas that are available for stover harvest, completion status of harvest from all available harvest areas, harvest completion by worker, transport status of units of stover from the harvest location, or any other data stored in database 335.

Many modifications and other embodiments will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method for managing a cellulosic biomass harvest comprising:
providing one or more harvest locations;
receiving at a processor a set of harvest location data associated with the one or more harvest locations;
generating at a processor one or more work orders for harvesting cellulosic biomass from the one or more harvest locations based on the set of harvest location data; and
storing in a database a cellulosic biomass harvest data set associated with the one or more harvest locations.

2. The method of claim 1 wherein providing one or more harvest locations comprises generating a map showing the harvest locations.

3. The method of claim 2 wherein providing one or more harvest locations further comprises dividing the map into a plurality of zones.

4. The method of claim 3 wherein providing one or more harvest locations further comprises dividing each zone into one or more land units.

5. The method of claim 4 wherein providing one or more harvest locations further comprises contracting with one or more owners of the land units.

6. The method of claim 4 wherein providing one or more harvest locations further comprises storing data associated with the land units in the database.

7. The method of claim 2 wherein generating a map further comprises displaying one or more properties of the harvest locations.

8. The method of claim 1 further comprising harvesting cellulosic biomass from the one or more harvest locations to form one or more units of cellulosic biomass.

9. The method of claim 8 wherein harvesting cellulosic biomass from the one or more harvest locations comprises selectively harvesting cellulosic biomass according to a harvesting plan.

10. The method of claim 9 wherein the harvesting plan comprises an environmental sustainability plan.

11. The method of claim 10 wherein the environmental sustainability plan comprises a harvesting prescription for leaving adequate cellulosic biomass on soil types susceptible to erosion.

12. The method of claim 1 further comprising indexing the one or more units of cellulosic biomass.

13. The method of claim 12 wherein indexing the units of cellulosic biomass comprises assigning a unique identifier to each unit of cellulosic biomass.

14. The method of claim 13 further comprising affixing an identification device to each unit of cellulosic biomass.

15. The method of claim 14 wherein the identification device is selected from the group consisting of human readable text, a bar code and an RFID tag.

16. The method of claim 1 wherein the harvest location data set comprises a cellulosic biomass provider name, a set of geospatial coordinates of the harvest location, one or more soil types of the harvest location, an image of vegetative cover at the harvest location, a set of crop yield data at the harvest location, a digital elevation model of the harvest location, a set of geospatial coordinates of a unit of cellulosic biomass, a moisture level of a unit of cellulosic biomass, a weight of a unit of cellulosic biomass, a vehicle location, a unique identifier for each unit of cellulosic biomass, a worker location, a vehicle type, a vehicle load capacity, a load level of a vehicle, weather data, or any combination thereof.
